(19) United States
(12) Patent Application Publication
(10) Pub. No.: US 2026/0004628 A1
(43) Pub. Date: Jan. 1, 2026

(54) FANTASY GAMEPAY WITHIN A GAMBLING BASED METAVERSE

(71) Applicant: IGT, Las Vegas, NV (US)

(72) Inventors: Daniel LANDRY, Moncton (CA); Michael RUSS, Graz (AT); Jackie ALVAREZ, Las Vegas, NV (US); Gaurav JARIWALA, Halifax (CA); David FROY, Lakeville-Westmorland (CA); Todd GRIMM, Riverview (CA); Aaron COREY, Moncton (CA); Bethany PLIMMER, Lower Coverdale (CA); David SMALL, Moncton (CA); Karen VAN NIEKERK, Dieppe (CA)

(73) Assignee: IGT, Las Vegas, NV (US)

(21) Appl. No.: 18/754,291

(22) Filed: Jun. 26, 2024

(51) Int. Cl. G07F 17/32

(52) U.S. Cl. CPC G07F 17/3211

(57) ABSTRACT

A system includes a processor circuit and a memory coupled to the processor circuit, the memory including machine-readable instructions that, when executed by the processor circuit, cause the processor circuit to perform operations. Such operations include providing, by the processor circuit, a virtual environment in a metaverse. The virtual environment includes a virtual electronic gaming machine (EGM), that receives, via the processor circuit and from a gaming device that is in a physical world, an identification of a first instance of the virtual environment that includes fantasy gameplay content that is not available in the physical world. Operations include generating, via the processor circuit, the first instance of the virtual environment that includes the fantasy gameplay content.

### BACKGROUND

Embodiments described herein relate to game play features with wagering games. In real-world slot machines such as electronic gaming machines (EGMs), the physical configuration and/or operation may place inherent limitations on certain aspects of game play. For example, game play of some features may be limited by the physics of EGMs. Thus, some features that could improve a player's experience may be impossible in the physical implementations of the real-world. As virtual gaming applications, such as metaverse applications, proliferate, there is a need to provide a wide variety of content for a wide variety of customers and customer interests that are not limited by the physical world.

### BRIEF SUMMARY

According to some embodiments, systems herein may include a processor circuit and a memory coupled to the processor circuit. The memory comprises machine-readable instructions that, when executed by the processor circuit, cause the processor circuit to perform operations. In some embodiments, the processor circuit is caused to provide a virtual environment in a metaverse. In some embodiments, the virtual environment includes a virtual electronic gaming machine (EGM). The processor circuit is further caused to receive, from a gaming device that is in a physical world, an identification of a first instance of the virtual environment that includes fantasy gameplay content that is not available in the physical world. The processor circuit is further caused to generate (block 706), via the processor circuit, the first instance of the virtual environment that comprises the fantasy gameplay content.

According to some embodiments, a gaming device includes a display device, an input device, a processor circuit and a memory coupled to the processor circuit. Embodiments include performing operations of causing the processor circuit to provide, a virtual environment in a metaverse, wherein the virtual environment includes a virtual electronic gaming machine (EGM). The processor circuit is further caused to receive, via the processor circuit and from a gaming device that is in a physical world, an identification of a first instance of the virtual environment that includes fantasy gameplay content that is not available in the physical world. The processor circuit is further caused to generate, the first instance of the virtual environment that includes the fantasy gameplay content. The processor circuit is further caused to provide, a second instance of the virtual environment that is different from the first instance and trigger a new instance of the virtual environment in response to an event in a different instance the virtual environment.

According to some embodiments, operations of systems/methods include several operations herein. Methods according to some embodiments include operations of providing, by a processor circuit, a virtual environment in a metaverse. The virtual environment includes a virtual electronic gaming machine (EGM). Operations include receiving, via the processor circuit and from a gaming device that is in a physical world, an identification of a first instance of the virtual environment that includes fantasy gameplay content that is not available in the physical world. Operations further include generating, via the processor circuit, the first instance of the virtual environment that comprises the fantasy gameplay content and providing a second instance of the virtual environment that is different from the first instance. Some embodiments include providing, in the virtual environment, multiple shared parallel instances that are associated with respective ones of the users.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is a perspective view of a gaming device that can be configured according to some embodiments.

FIG. 2E is a perspective view of a gaming device according to further embodiments.

FIGS. 2F and 2G illustrate VR/AR devices according to various embodiments.

FIG. 3 is a schematic block diagram of a metaverse according to some embodiments.

FIG. 4 is a schematic block diagram of a metaverse according to some embodiments.

FIG. 5 is a schematic block diagram of a metaverse according to some embodiments.

FIG. 6 is a schematic block diagram of a metaverse according to some embodiments.

FIG. 7 is a flowchart illustrating operations of systems/methods of generating and providing a virtual wagering game is illustrated, according to some embodiments.

FIG. 8 is a flowchart illustrating operations of systems/methods of generating and providing a virtual wagering game is illustrated, according to some embodiments.

FIG. 9 is a flowchart illustrating operations of systems/methods of generating and providing a virtual wagering game is illustrated, according to some embodiments.

### DETAILED DESCRIPTION

Embodiments herein may relate to using a virtual EGM to provide game play features that include a fantasy game component and/or feature that may otherwise be impossible using a physical EGM or other type of slot machine.

As provided herein, embodiments may focus on addressing “fantasy gameplay” within a gambling-based metaverse environment with parallelized and/or personalized instances. Various embodiments may include various different methods and features of fantasy gameplay for games of chance. As provided herein, the term “fantasy gameplay” may be described as playing mechanics, game concepts, personal game and/or game element adjustments, and/or creating multiple virtual instances of the same game in ways that are not possible in the real physical world but are possible in a virtual world, such as within a metaverse.

Some embodiments provide that a virtual world is appealing for new players such as younger generations that may be more familiar with the latest technologies, but not yet attracted by traditional gambling amenities. The virtual world may also be appealing to existing players to expand their horizon of existing gambling experiences without being bound by real-world limitations of space and time.

Real world casinos may be limited to the physical constraints of the real world, such as gravity, limited space, and/or required revenue generation within a given time period, which may be termed casino floor average. Based on these constraints, game designers, manufacturers and/or operators, among others, may be limited in the game offerings they can provide to their players. Such drawbacks may not be negotiable.

However, in a virtual world, such as within a metaverse, such physical constraints may be overcome completely. The capabilities of the virtual world may be effectively limitless through which entirely new game mechanics, designs, and/or virtual devices can be generated to create whole new player experiences.

Further, since the metaverse may provide infinite number of different parallel instances, there may be no limitation of “1 square meter of space must create X $ per hour.” Instead, we can simply spin-off multiple parallel instances. Further, some embodiments provide that everything happening can be associated with much more thrill, excitement and fun through appealing effects of side plays, which may not be limited by time and/or space boundaries.

Fantasy gameplay in a metaverse may rely on numerous technologies, concepts and/or components for using and/or accessing a metaverse. Using a metaverse may include technologies to enter a metaverse, immersive technologies, such as, virtual reality, augmented reality, and/or mixed reality, among others. Other components may include traditional home entertainment technologies such as a desktop computer, a laptop computer, mobile devices and/or browser-based components, among others. Further components may include devices to create haptic sensations, such as VR gloves, VR suits, and/or VR controllers, among others. Operations supported in the metaverse include virtual betting and/or back-betting systems in the metaverse. Operations may further include tracking users, user actions, user accounts, user credits, and/or user statistics, among others. Some embodiments of the metaverse allow betting on virtual games, other virtual players' actions and/or the outcome of various virtual events, among others. Some embodiments provide a “metaverse options menu” that enables the user to customize, personalize and/or change their metaverse experience. In some embodiments, personal settings may be generated and/or stored for each individual. Personal settings may be used to adjust visuals, sounds, and/or notifications, among others, within their personal metaverse experience. Personal settings may be used to adjust settings with technologies such as immersive technologies and/or haptic sensation technologies, among others.

Some embodiments provide that a metaverse server infrastructure may allow multiple shared and/or personal parallel instances may be shared. By sharing instances and/or using multiple parallel instances a shared metaverse experience may be shared amongst all of the players in the metaverse. Some embodiments provide that the shared metaverse experience may also include one or more private separate instances in which a player may share their metaverse instance with other players, but your instance looks different than other players' metaverse. For example, an individual may change the theme of the virtual casino only for their own instance and keep the remaining instances as the default theme for all other players. Some embodiments may allow a group of individuals, such as, for example, friends and/or players within the same game setup, to have their own separate instance that may be different from other players. In some embodiments, a group of individuals may play at the same bank of virtual machines, and once a bonus is triggered, they enter a completely different world, as they play the bonus.

In a casino-related context, the metaverse may be a virtual place where users can play casino-like games, interact with other players, engage in social activities, and/or attend virtual concerts and/or events, among others. In some embodiments, players may be able to create avatars to represent themselves in the virtual world. Players may earn virtual currency that can be used to purchase virtual goods, trade, and/or exchange, even for real currency.

Embodiments herein may be suitable for using AR and/or VR, however, such embodiments are not so limited because traditional home use technology may be effectively used. In some embodiments, the metaverse may be able to blur the line between virtual and physical reality.

According to some embodiments, the metaverse may allow live events to be visually replaced and/or modified. For example, an instance may be re-skinned to provide a different color, theme or other visually modified effect. New themes may be fantasy themes and/or people.

In some embodiments, a player may wager on horse race and have an avatar image in place on top of real jockey. In some embodiments, the instance in the metaverse may link directly and/or indirectly link directly to a real-world live event in real-time but in virtual world. In such embodiments, the player may be able to customize the race to change the horse to a fantasy animal including, for example, a creature from one or more licensed fantasy shows and/or books.

In some embodiments, there can be a real-world horse race happening and the player may be a virtual player and the virtually, but you as a virtual player watch it virtually, and in that virtual world, instead of having horses running, it could be ANY other fantasy object running. The outcome would be the same since it is linked to the real world, but the player may experience the horse race as a completely different experience, based on personalized elements.

In some embodiment, real world events may be enhanced in a virtual realm. For example, a poker game may be played and presented as dogs playing poker.

Some embodiments provide that a player may find, select and/or define co-workers to play with in a given instance. In some embodiments, a player may gamble with a favorite celebrity as a buddy.

In some embodiments, a player may experience a transport to different virtual viewing locations and viewing experiences and/or participation of an event from different locals. For example, a viewing location may include the center of action such as a center of a colosseum. Some embodiments provide that play could be in the middle of a virtual casino, among others. In some embodiments, the virtual casinos may be identical to existing casinos that are provided in a different location. Some embodiments provide that the actual layouts of the virtual casinos may display live events occurring therein.

Some embodiments may provide tours of famous may be provided in an instance of the metaverse.

Some embodiments, the metaverse may include historical gaming in which a player may go back in time and gamble with Roman or Aztec games. Some embodiments include playing casino slots, sports and/or table games at landmarks and/or historical sites. Examples include wagering on a boxing event in the colosseum.

Some embodiments include portals to other casinos from your home base casino to try out other locations and/or to game with friends. Players may participate in a virtual casino crawl or play the top games in each casino one at a time. An enhanced win experience may be tailored to a personal wager on live events.

In some embodiments, in response to wagering on a winning horse, after the event is over, a player may be offered to a chance to own their own personally tailored win experience. Some embodiments include a chance to take a picture with your horse (or other racing animal or vehicle”.

Some embodiments provide that a separate “metaverse instance” may be spun off for every winner, so that each winner has their own tailored win experience. In such cases, the “real person virtual characters” or “NPC characters” may be part of a player's personal instance and may celebrate your win with you. In this manner, the win celebration and feeling of happiness may be prolonged and increased. Some embodiments provide that all winners are within the same instance and are able to celebrate together and/or congratulate each other. Each winner may see the “winning horse” as their own fantasy “horse”.

Some embodiments provide that AI generated experiences based on real players and event tournaments like world poker tour, may be at the final table and may try to outplay players from a classic match. Such classic matches may be recreated and may have a personal impact on past events.

In some embodiments, an instance may play famous sports matches and/or interact with the game by red carding certain players or injuring certain players and betting on alternate outcomes. Further, a player may watch and participate in table games with famous players. For example, a re-play of a famous world poker series from 2000 may include having the play behavior of the players from there re-created using AI. The player may try to compete against these famous players in the player's metaverse instance and may potentially change the outcome as the player beats the famous players.

Some embodiments provide that a player may participate in live events of popular gameshows hosted by AI of real hosts. For example, AI/Chat GPT may be operative to host game shows in the metaverse instance. Hosting any number of different game shows may be hosted anytime for anyone to join in real game setting in Metaverse. Some embodiments provide a virtual game show, that players can join in, watch and/or back-bet on.

In-game fantasy experiences in which the player becomes part of the game may have an impact on the game while the player is doing something else. For example, being part of the game and/or the game's scenery may have a perceived impact on the game.

Some embodiments include a virtual scavenger hunt. The easter hunt may be played in a given environment that the game is set in and the player may look for and find easter eggs while the game is running.

In some embodiments, the metaverse instance may allow the virtual player to walk inside and around stepper reels while the game is playing. The spin may be influenced or initiated by interacting with reels.

Some environments include a revival of chill-based gaming in which players play more real games while the game of chance mechanisms are running in the background. Also, for this type of game, a player may have much more freedom in game design within the metaverse.

Some embodiments provide that reel spins could take much longer. For example, while the reels of a virtual slot game are spinning, the player may be virtually inside the virtual slot game, playing a game such as a first-person shooter. The player may shoot at some break buttons inside the virtual slot machine to force the reels to spin. Reel spins could take as long as the player requires to shoot all break buttons.

In some embodiments, multiple players may play the same slot game at the same time in which each player may have their own instance of the game and each player may play their own preferred intermediate game during that.

Some embodiments provide that roulette spins may take much longer. For example, some embodiments include the roulette ball as a fantasy version of the player. Such versions may provide that the roulette ball jumps around to provide a dynamic performance to the player. As such, the player may watch more than just the ball landing in a wedge on the roulette wheel. Such embodiments can have an impact on where the ball moves towards. For example, the player in the metaverse instance may nudge the machine, shake the table, accelerate it to a certain direction, and/or perform some “skill-movements” to impact the moving direction, among others. In some embodiments, multiple players might “be the ball” at the same time, and the movement of the ball is the resulting outcome of all player-ball-interactions.

In some embodiments, a player may wager on outcomes of gaming experiences, events and/or team battles, among others, that are taking place in metaverse. Some embodiments include wagering on virtual world events such as guessing the daily number of visitors, an outcome to a virtual bingo game, results from a lottery drawing, the number of jackpots triggered and/or the total money amount won that day within the virtual casino, among others.

In some embodiments, a player may build their own gaming experience. For example, a player may build their own multi-channel metaverse that includes favorite games and/or locations, among others.

Some embodiments include a metaverse game theme developed using voice inputs/outputs. Such games may be developed by multiple players and/or may be based on an upgraded theme by a previous player.

Some embodiments provide that a unique game theme may be randomly auto-generated based on some player-selected parameters. In some embodiments, the player's game game randomly changes to be a different version that looks like it's from an alternate universe. Some embodiments provide that a multi-game line-up may be created and that includes games from different manufacturers and/or a given casino.

As provided herein, by using the metaverse, players can immerse themselves into the slot games that they play, allowing for different experiences that would not be possible in real-world game play situations. In this manner, the game play experience may expand in a way that allows for “fantasy” real like scenarios to play out in a virtual world where the laws of physics may be suspended and such scenario's may only be performed in a fantasy of the real world.

In some embodiments, the metaverse may provide that a user playing a game show these casino game can be transported into the game show as a real or fantasy contestant. For example, in a given game show-based game, a player may find themselves on the stage at the game show studios where a fantasy feature of the show may be present. Upon triggering a bonus corresponding to the fantasy feature, the player gets to simulate actuating that feature as it appears on the show to determine their bonus win.

Some embodiments provide the ability to play multiple ones of your favorite games at the same time. Example embodiments may include an EGM and a table game that are situated proximate one another so both can be played without the player having to leave one game to play the other. One example includes a craps table and a particular EGM that may be played at the same time. In the metaverse, a player can set up their world to have a slot machine “delivered” right next to the craps table. While they are wagering craps (but not rolling the dice), they could be wagering on the EGM.

Some embodiments provide a pay to replay feature in which a player and/or avatar loses all their money in their metaverse game play experience. In such embodiments, the player may place a wager to replay their experience to determine if the outcome would be different. In some embodiments, this may be provided for a particular pick-bonus and/or another skill-based game.

Some embodiments provide warp into game feature in which a player triggers a bonus and thus may be warped into the game to play that particular bonus. For example, a game in which a virtual creature or object may select which destination for the virtual creature to be moved. The different destinations may provide different amounts and/or types of credits that may be collected by the player. The player can transition or warp into the game and become the virtual creature or object and make the jumps themselves to collect their prizes.

Embodiments described herein relate to game play features with wagering games, and providing EGM features for virtual wagering games and gaming environments, and related devices, systems, and methods. For a virtual gambling (e.g., casino play) application, the system may manage and track user transactions in the venue. In some embodiments a virtual casino venue may be a virtual location where users can play casino-like games, interact with other players, and/or engage in social activities such as attending virtual concerts or events. Players may be able to create avatars to represent themselves in the virtual world, can earn virtual currency that can be used to purchase virtual goods, traded, or even exchanged for real money. The virtual casino and other metaverse experiences can be provided through a variety of devices and technologies, such as virtual reality (VR), augmented reality (AR), personal computing devices, mobile computing devices, home entertainment technologies such as smart televisions and/or set-top boxes, among others.

In some embodiments, the system may include an app or features for providing guided tours of the virtual venue or other amenities, such as a virtual preview through the app before an actual visit, a preview of the available games, and/or a game finder feature, for example.

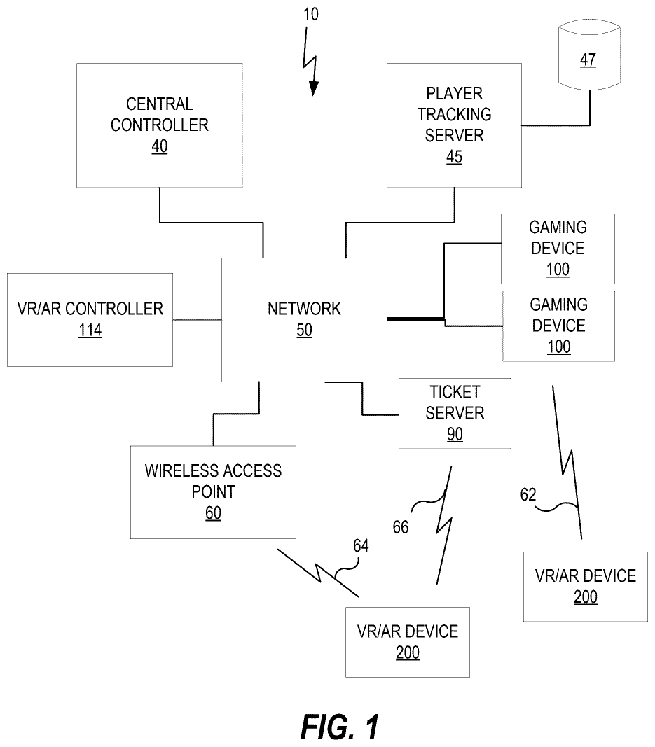

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

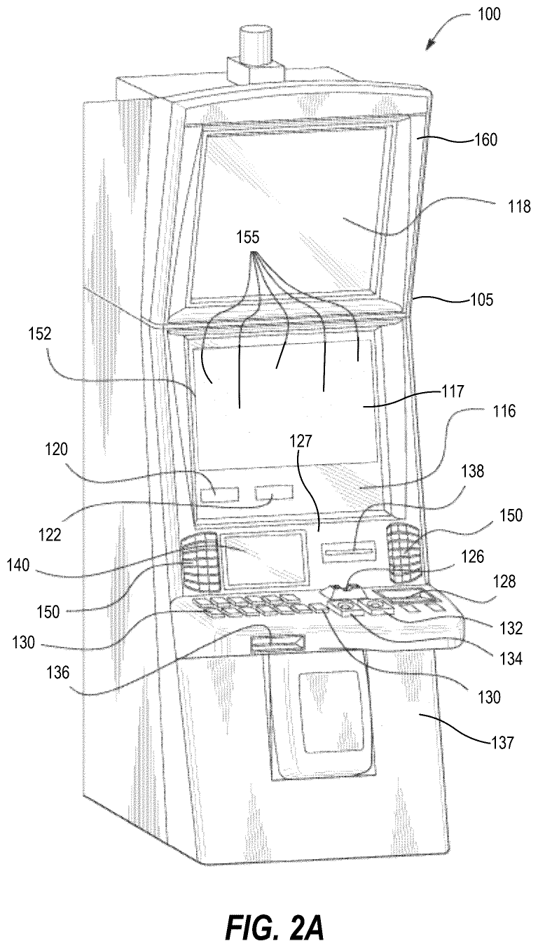

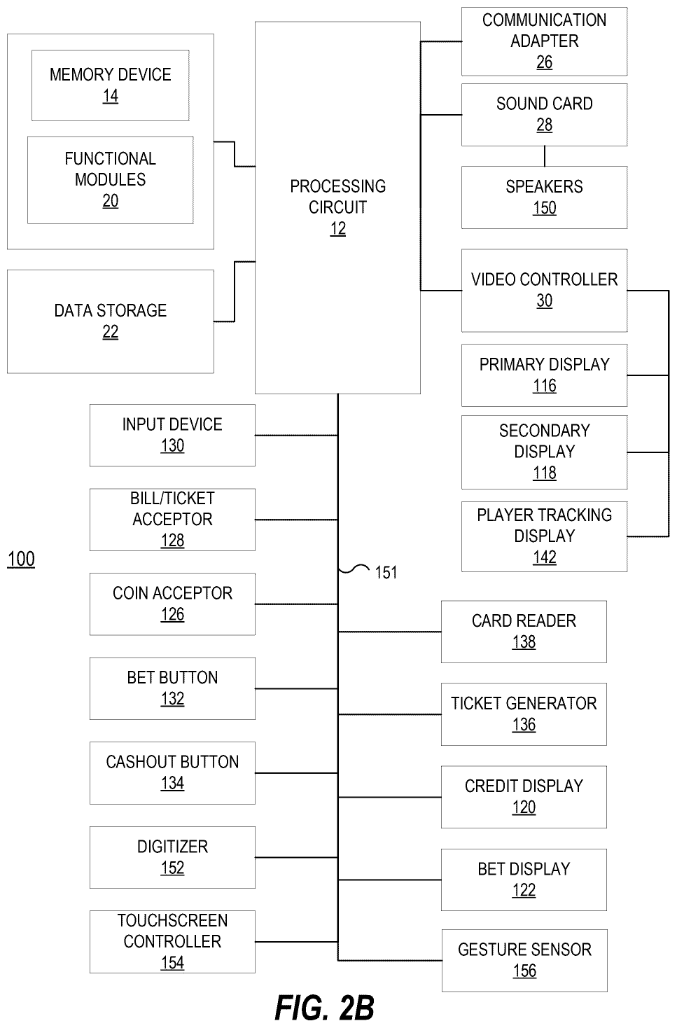

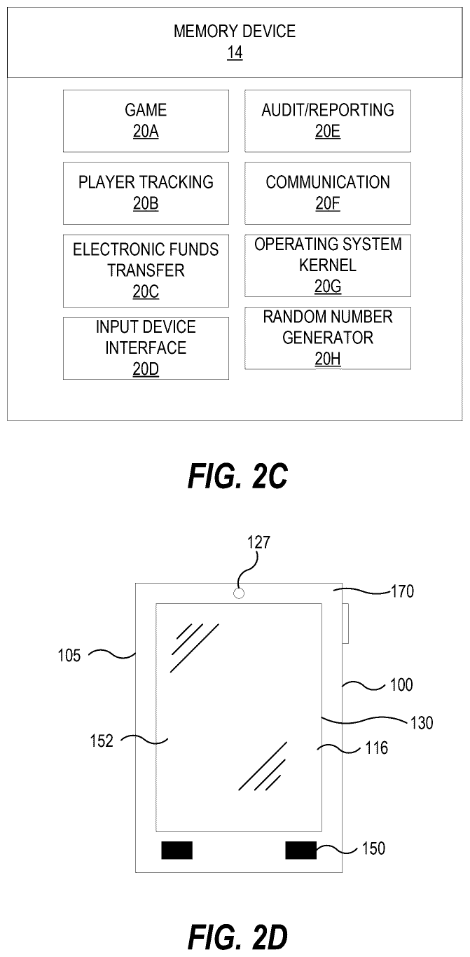

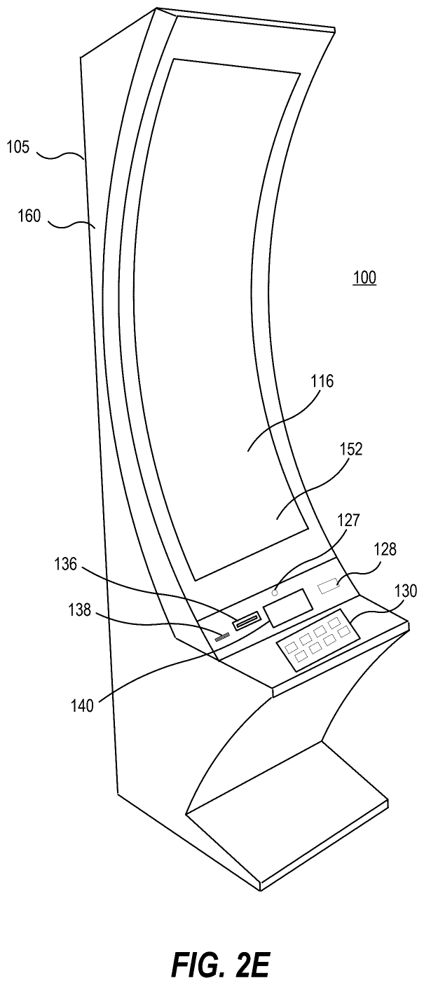

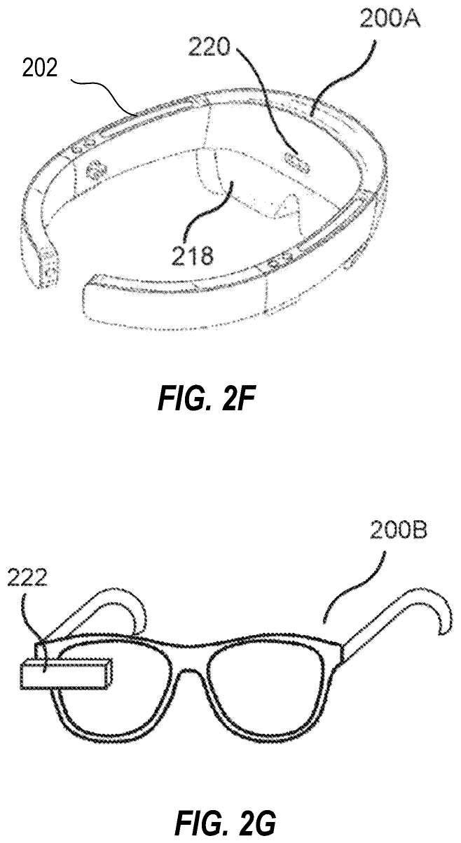

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processor circuit through a USB hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

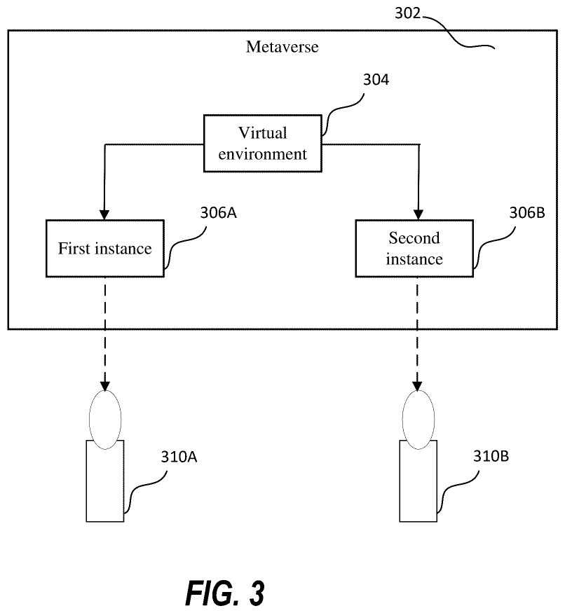

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

FIG. 2F illustrates a virtual reality (VR) viewer 200A implemented as a 3D headset including a pair of displays 218 on which images of virtual objects may be displayed. The viewer 200A includes a head-wearable frame 202, with the displays 218 coupled to the frame 202 to position the display device in a field of view of user wearing the viewer 200A. Different stereoscopic images may be displayed on the displays 218 to create an appearance of depth. The VR viewer 200A may include a plurality of sensors 220 that the device uses to determine a position, orientation, and/or movement of the viewer 200A, which may be used to determine a position, orientation, and/or direction of movement within an SVE.

The viewer 200A may further include other sensors, such as a gyroscopic sensor, a GPS sensor, one or more accelerometers, and/or other sensors that allow the viewer 200A to determine its position and orientation in space. In some embodiments, the viewer 200A may include one or more cameras that allow the viewer 200A to determine its position and/or orientation in space using visual simultaneous localization and mapping (VSLAM). viewer 200A may further include one or more microphones and/or speakers that allow the user to interact audially with the device.

In some embodiments, a viewer may also include semitransparent lenses that allow the user to see both the real world as well as the 3D image rendered on the lenses, e.g., to provide an augmented reality (AR) experience. The viewer may also include additional cameras or other sensors to obtain a live video signal for building a 3D model of the space around the user. The viewer may also generate a 3D image of an object to display to the user that takes into account the real-world objects around the user and allows the user to interact with the 3D object.

Referring to FIG. 2G, an augmented reality (AR) viewer 200B may be implemented as a pair of glasses including a transparent prismatic display 222 that displays an image to a single eye of the user. Such a device may be capable of displaying images to the user while allowing the user to see the world around the user, and as such can be used as an AR device.

In other embodiments, a VR and/or AR viewer may be implemented using a virtual retinal display device that raster scans an image directly onto the retina of the user. In still further embodiments, a VR and/or AR viewer may be implemented using a mobile wireless device, such as the mobile gaming device 170 of FIG. 2D above, a mobile telephone, a tablet computing device, and/or a personal digital assistant, etc.

Although illustrated as certain gaming devices, such as electronic gaming machines (EGMs), mobile gaming devices, VR/AR headsets, etc., functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Reference is now made to FIG. 3, which is a schematic block diagram of a metaverse according to some embodiments. In some embodiments, the metaverse 302 may include one or more virtual environments 304. In some embodiments, a first instance 306A of the virtual environment may be provided to a first user 310A. As discussed above, the first instance 306A may include fantasy elements that may be exclusively available to the first user 310A.

In some embodiments, a second instance 306B of the virtual environment may be provided to a second user 310B. As discussed above, the second instance 306B may include fantasy elements that may be exclusively available to the second user 310B. In some embodiments, the first instance 306A and the second instance 306B may be provided to the first user 310A and the second user 310B in parallel with one another.

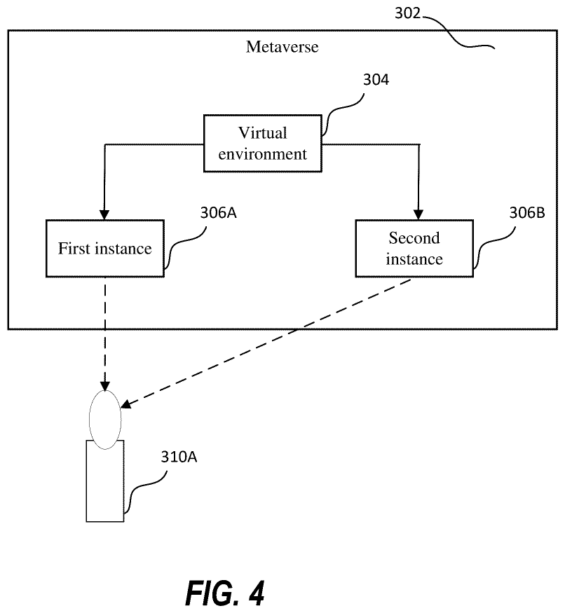

Brief reference is now made to FIG. 4, which is a schematic block diagram of a metaverse according to some embodiments. Consistent with FIG. 3, the metaverse 302 includes a virtual environment 304 that may include a first instance 306A of the virtual environment 304. Some embodiments provide that a second instance 306B of the virtual environment 304 may be provided. In some embodiments, both the first instance 306A and the second instance 306B may be available to the first user 310. In some environments, multiple instances 306 may be generated to correspond to events or other activities in the virtual environment 304.

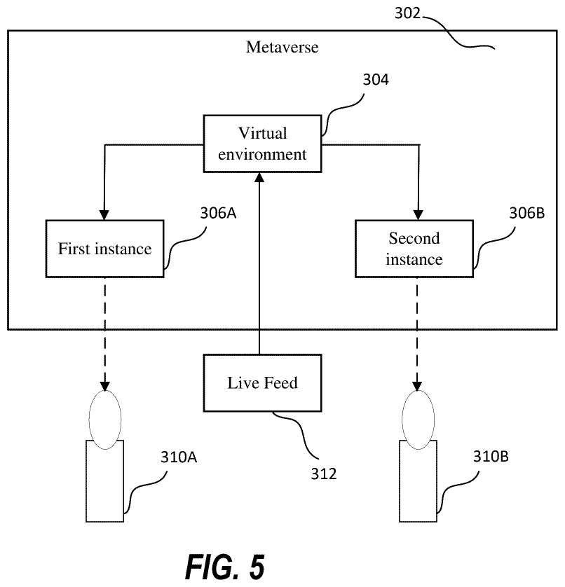

Brief reference is now made to FIG. 5, which is a schematic block diagram of a metaverse according to some embodiments. Similar to embodiments discussed above regarding FIG. 3, the metaverse 302 includes a virtual environment 304 and at least two different instances 306A, 306B of the virtual environment 304. In some embodiments, the virtual environment may include content corresponding to a live feed 312. The live feed 312 may include a live event content corresponding to a sporting event, a live show, a gathering of people, and/or video and/or audio content, among others.

In some embodiments, the first instance 306A may include fantasy content that supplements and/or replaces a portion of the live feed 312. Some embodiments provide that the second instance 306B may include fantasy content that corresponds to one or more portions of the live feed 312 and that is different from the first instance 306A. For example, the first and second instances 306A, 306B may each include fantasy content that has different themes, colors, images, audio content, fantasy characters, and/or fantasy animals, among others.

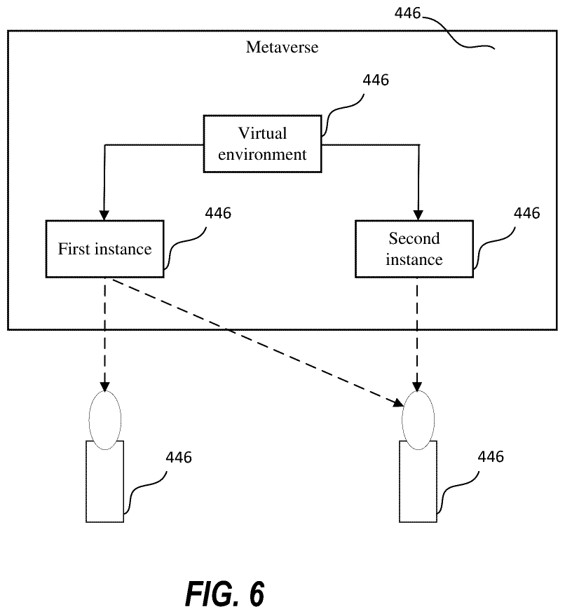

Brief reference is now made to FIG. 6, which is a schematic block diagram of a metaverse according to some embodiments. Similar to embodiments discussed above regarding FIG. 3, the metaverse 302 includes a virtual environment 304 and at least two different instances 306A, 306B of the virtual environment 304. In some embodiments, the first instance 306A is available to both the first user 310A and the second user 310B. In such embodiments, the second instance 306B may be available to the second user 310B and not available to the first user 310A. Although discussed herein in the context of first and second users, such embodiments are not so limiting. For example, the first instance 306A may be shared with one or more groups of users 310.

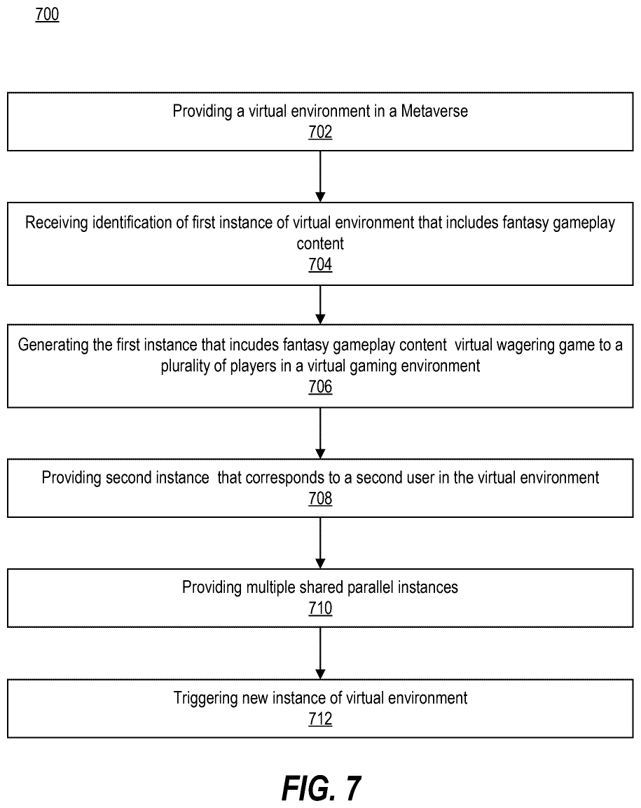

Reference is now made to FIG. 7, which is a flowchart illustrating operations of systems/methods of generating and providing a virtual wagering game is illustrated, according to some embodiments. Systems herein may include a processor circuit and a memory coupled to the processor circuit. The memory comprises machine-readable instructions that, when executed by the processor circuit, cause the processor circuit to perform operations. In some embodiments, the processor circuit is caused to provide (block 702) a virtual environment in a metaverse. In some embodiments, the virtual environment includes a virtual electronic gaming machine (EGM). The processor circuit is further caused to receive (block 704), from a gaming device that is in a physical world, an identification of a first instance of the virtual environment that includes fantasy gameplay content that is not available in the physical world. The processor circuit is further caused to generate (block 706), via the processor circuit, the first instance of the virtual environment that comprises the fantasy gameplay content.

In some embodiments, the processor circuit is further caused to provide (block 708) a second instance of the virtual environment that is different from the first instance. In some embodiments, the first instance corresponds to a first user in the virtual environment and the second instance corresponds to a second user in the virtual environment. Some embodiments provide that the virtual environment includes content corresponding to a live event feed. In some embodiments, the first instance of the virtual environment includes first fantasy content that is caused to be in the first instance of the virtual environment and the second instance of the virtual environment includes second fantasy content that is caused to be in the second instance of the virtual environment.

In some environments, the live event feed is modified via the first fantasy content in the first instance of the virtual environment and the live event feed is modified via the second fantasy content in the second instance of the virtual environment. Some embodiments provide that the first fantasy content is different from the second fantasy content.

In some embodiments, the fantasy gameplay content includes personal game adjustments that correspond to user preferences in the virtual environment and that are not achievable in the physical world. Some embodiments provide that the processor circuit is further caused to provide (block 710), in the virtual environment, multiple shared parallel instances that are associated with respective ones of multiple users. In some embodiments, the multiple shared parallel instances includes a first shared parallel instance corresponding to a first user and a second shared parallel instance corresponding to a second user. In some embodiments, the multiple shared parallel instances may be exclusively shared with another one of the multiple shared parallel instances. In some embodiments, the multiple users include a group of users that are associated with one another exclusive of the ones of the multiple users.

In some embodiments, the first instance of the virtual environment includes first fantasy gameplay content that corresponds to first historical gaming content that is associated with a first time in history, and a second instance of the virtual environment includes second fantasy gameplay content that corresponds to second historical gaming content associated with a second time in history that is different from the first time in history.

In some embodiments, the processor circuit is further caused to trigger (block 712) a new instance of the virtual environment in response to an event in a different instance of the virtual environment. In some embodiments, ones of multiple instances of the virtual environment are generated responsive to an associated user including a wagering outcome.

In some embodiments, multiple users are associated with a single one of multiple instances of the virtual environment. Some embodiments provide that the multiple users celebrate in a celebration together in a single instance. In some embodiments, the fantasy gameplay content includes artificial intelligence content that provides likeness of real players and events that are playable in the first instance.

In some embodiments, the fantasy gameplay content includes artificial intelligence content corresponding to a live event game show. Some embodiments provide that other users may join the first instance of the live event game show. In some embodiments, the fantasy gaming content includes an in-game experience that includes a user being within a portion of a virtual EGM and that the user interacts with EGM elements to cause an effect of the user affecting an outcome of game play. In some embodiments, in the first instance of the virtual environment, a depiction of the user includes one of the EGM elements and is caused to be guided to appear to achieve an outcome at the EGM.

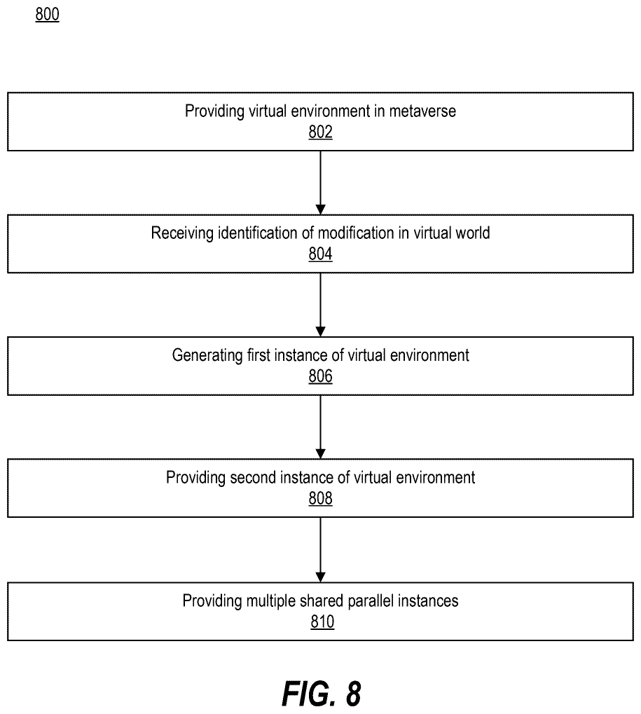

Reference is now made to FIG. 8, is a flowchart illustrating operations of systems/methods of generating and providing a virtual wagering game is illustrated, according to some embodiments. Methods according to some embodiments include operations of providing (block 802), by a processor circuit, a virtual environment in a metaverse. The virtual environment includes a virtual electronic gaming machine (EGM). Operations include receiving (block 804), via the processor circuit and from a gaming device that is in a physical world, an identification of a first instance of the virtual environment that includes fantasy gameplay content that is not available in the physical world. Operations further include generating (block 806), via the processor circuit, the first instance of the virtual environment that comprises the fantasy gameplay content and providing (block 808) a second instance of the virtual environment that is different from the first instance. Some embodiments include providing (block 810), in the virtual environment, multiple shared parallel instances that are associated with respective ones of the users.

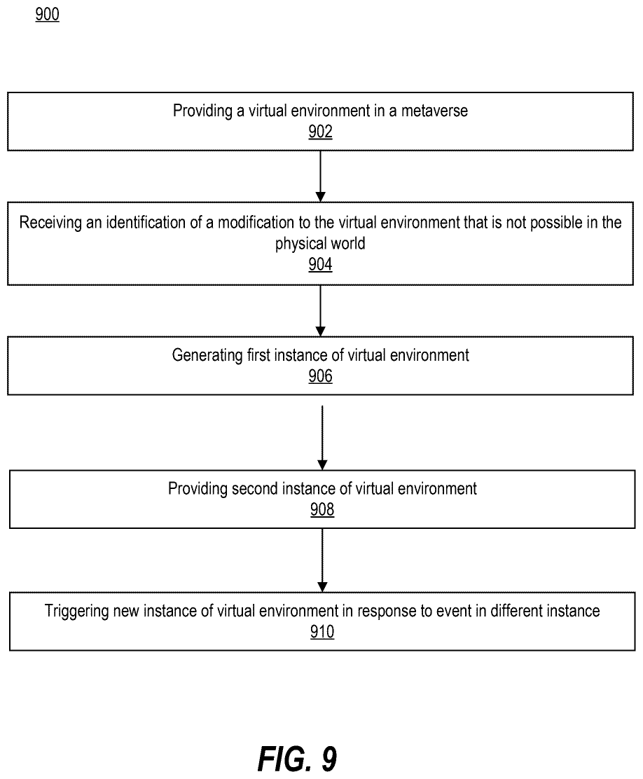

Reference is now made to FIG. 9, which is a flowchart illustrating operations of systems/methods/devices of generating and providing a virtual wagering game is illustrated, according to some embodiments. A gaming device includes a processor circuit and a memory coupled to the processor circuit. The memory includes machine-readable instructions that, when executed by the processor circuit, cause the processor circuit to provide (block 902), a virtual environment in a metaverse, wherein the virtual environment comprises a virtual electronic gaming machine (EGM). The processor circuit is further caused to receive (block 904), via the processor circuit and from a gaming device that is in a physical world, an identification of a first instance of the virtual environment that comprises fantasy gameplay content that is not available in the physical world. The processor circuit is further caused to generate (block 906), the first instance of the virtual environment that includes the fantasy gameplay content. The processor circuit is further caused to provide (block 908), a second instance of the virtual environment that is different from the first instance and trigger (block 910) a new instance of the virtual environment in response to an event in a different instance the virtual environment.

Some embodiments provide that the modification to the virtual environment includes a modification to change a characteristic of the virtual EGM in the virtual environment. In some embodiments, the virtual EGM includes a virtual slot machine and the characteristic corresponds to a quantity of reels in the virtual slot machine. In some embodiments, the characteristic includes a selectable quantity of reels. Some embodiments provide that a limit on wager content is based on the reels in the virtual slot machine. Ins some embodiments, the virtual EGM includes a virtual slot machine. Some embodiments provide that the virtual EGM includes the characteristic corresponding to a reel height in the virtual slot machine and the characteristic includes a selectable reel height. Some embodiments provide that there is a limit on wager content that is based on the reel height in the virtual slot machine.

In some embodiments, the user includes a user avatar in the metaverse that corresponds to the user. Some embodiments provide that the virtual EGM includes a skill-based game, and the metaverse includes a spectator avatar corresponding to another user that is watching the user's performance on the virtual EGM. In some embodiments, the processor circuit is caused to receive a wager from the spectator avatar based on the user's performance in the virtual EGM.

Some embodiments provide that, in response to the user triggering a given bonus, the processor circuit is caused to transfer the user within the metaverse to the virtual environment that corresponds to the given bonus. In some embodiments, the processor circuit is caused to merge content of multiple virtual EGMs into a single EGM.

In some embodiments, a gaming device may be operated by a mobile device, such as a mobile telephone, tablet and/or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
provide, by the processor circuit, a virtual environment in a metaverse, wherein the virtual environment comprises a virtual electronic gaming machine (EGM);
receive, via the processor circuit and from a gaming device that is in a physical world, an identification of a first instance of the virtual environment that comprises fantasy gameplay content that is not available in the physical world; and
generate, via the processor circuit, the first instance of the virtual environment that comprises the fantasy gameplay content.

2. The system of claim 1, wherein the processor circuit is further caused to provide a second instance of the virtual environment that is different from the first instance.

3. The system of claim 2, wherein the first instance corresponds to a first user in the virtual environment and the second instance corresponds to a second user in the virtual environment.

4. The system of claim 2, wherein the virtual environment comprises content corresponding to a live event feed,
wherein the first instance of the virtual environment comprises first fantasy content that is caused to be in the first instance of the virtual environment, and
wherein the second instance of the virtual environment comprises second fantasy content that is caused to be in the second instance of the virtual environment.

5. The system of claim 4, wherein the live event feed is modified via the first fantasy content in the first instance of the virtual environment,
wherein the live event feed is modified via the second fantasy content in the second instance of the virtual environment, and
wherein the first fantasy content is different from the second fantasy content.

6. The system of claim 1, wherein the fantasy gameplay content comprises personal game adjustments that correspond to user preferences in the virtual environment and that are not achievable in the physical world.

7. The system of claim 1, wherein the processor circuit is further caused to provide, in the virtual environment, a plurality of shared parallel instances that are associated with respective ones of a plurality of users.

8. The system of claim 7, wherein the plurality of shared parallel instances comprises a first shared parallel instance corresponding to a first user and a second shared parallel instance corresponding to a second user.

9. The system of claim 7, wherein one of the plurality of shared parallel instances is exclusively shared with another one of the plurality of shared parallel instances.

10. The system of claim 7, wherein the plurality of users comprises a group of users that are associated with one another exclusive of the ones of the plurality of users.

11. The system of claim 1, wherein the first instance of the virtual environment comprises first fantasy gameplay content that corresponds to first historical gaming content that is associated with a first time in history, and
wherein a second instance of the virtual environment comprises second fantasy gameplay content that corresponds to second historical gaming content associated with a second time in history that is different from the first time in history.

12. The system of claim 1, wherein the processor circuit is caused to trigger a new instance of the virtual environment in response to an event in a different instance of the virtual environment.

13. The system of claim 1, wherein ones of a plurality of instances of the virtual environment are generated responsive to an associated user comprising a wagering outcome.

14. The system of claim 1, wherein a plurality of users is associated with a single one of a plurality of instances of the virtual environment, and
wherein the plurality of users participate in a celebration together.

15. The system of claim 1, wherein the fantasy gameplay content comprises artificial intelligence content that provides likeness of real players and events that are playable in the first instance.

16. The system of claim 1, wherein the fantasy gameplay content comprises artificial intelligence content corresponding to a live event game show, and
wherein other users may join the first instance of the live event game show.

17. The system of claim 1, wherein the fantasy gaming content comprises an in-game experience that comprises a user being within a portion of a virtual EGM and that the user interacts with EGM elements to cause an effect of the user affecting an outcome of game play.

18. The system of claim 17, wherein, in the first instance of the virtual environment, a depiction of the user comprises one of the EGM elements and is caused to be guided to appear to achieve an outcome at the EGM.

19. A method comprising:
providing, by a processor circuit, a virtual environment in a metaverse, the virtual environment comprising a virtual electronic gaming machine (EGM);
receiving, via the processor circuit and from a gaming device that is in a physical world, an identification of a first instance of the virtual environment that comprises fantasy gameplay content that is not available in the physical world;
generating, via the processor circuit, the first instance of the virtual environment that comprises the fantasy gameplay content;
providing a second instance of the virtual environment that is different from the first instance; and
providing, in the virtual environment, a plurality of shared parallel instances that are associated with respective ones of a plurality of users.

20. A gaming device comprising:
a processor circuit; and
a memory coupled to the processor circuit, the memory comprising machine-readable instructions that, when executed by the processor circuit, cause the processor circuit to:
provide, by the processor circuit, a virtual environment in a metaverse, wherein the virtual environment comprises a virtual electronic gaming machine (EGM);
receive, via the processor circuit and from a gaming device that is in a physical world, an identification of a first instance of the virtual environment that comprises fantasy gameplay content that is not available in the physical world;
generate, via the processor circuit, the first instance of the virtual environment that comprises the fantasy gameplay content;
provide, via the processor circuit, a second instance of the virtual environment that is different from the first instance; and
trigger a new instance of the virtual environment in response to an event in a different instance the virtual environment.
